(19) United States
(12) Patent Application Publication
(10) Pub. No.: US 2006/0047494 A1
(43) Pub. Date: Mar. 2, 2006

(54) Circuit analysis method and circuit analysis apparatus

(75) Inventors: Hirotaka Tamura, Kawasaki (JP); Hisakatsu Yamaguchi, Kawasaki (JP); Marcus van Ierssel, Toronto (CA)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/042,066

(22) Filed: Jan. 26, 2005

(30) Foreign Application Priority Data
Aug. 30, 2004 (JP) 2004-250274

(51) Int. Cl. G06F 17/50

(52) U.S. Cl. 703/19

(57) ABSTRACT

A step response of a clock synchronous circuit including a bandwidth restriction effect of a transmission path is extracted from circuit data on a simulation subject. A second discrete time model is generated by applying the response function to a first discrete time model generated from the circuit data. Using the second discrete time model, clock edge timing and an effective signal value of a signal input to/output from the clock synchronous circuit at this timing are calculated for simulation execution. Analogically accurate simulation of a circuit operation around a sampling edge of a clock enables precise simulation with a minimum calculation in a short time. Accordingly, the invention can provide an accurate simulation method for accurately modeling an analog operation of a signal transmission circuit that inputs and outputs a high-speed signal, to calculate in a short time.

### CROSS REFERENCE TO RELATED APPLICATION

This application is based upon and claims the benefit of priority from Japanese Patent Application No. 2004-250274, filed on Aug. 30, 2004, the entire contents of which are incorporated herein by reference.

### BACKGROUND OF THE INVENTION

1. Field of the Invention

The present invention relates to a technique for performing, at high speed, signal transmission between LSI chips, elements and circuit blocks in an LSI chip, boards, or cases. In particular, the invention relates to a circuit analysis method for designing a circuit that is used for such a technique.

2. Description of the Related Art

The performance of components of data processing apparatus such as computers has been improving rapidly with the development of LSIs (semiconductor integrated circuits). For example, the performance of SRAMs, DRAMs, processors, and switching LSIs continues to improve year by year. To enhance the performance of systems accordingly, it is necessary to increase the speed of signal transmission between such components or circuits. That is, it is necessary to increase signal transmission rates that are measured in bits/s and to thereby decrease transmission delays. For example, with increase in processing speeds of processors and logic LSIs, the difference between the signal transmission rates of a memory and a processor (or logic LSI) is coming to prevent increase in the performance of a computer. With increase in chip size, not only the speed of signal transmission between chips but also that between the elements and circuit blocks in a chip is becoming a major factor of restricting the chip performance. Further, it is necessary to increase the speed of signal transmission in the connections between servers or boards.

As the speed of signal transmission between circuit blocks, chips, or cases increases, various problems relating signal quality arise, an example of which is attenuation of high-frequency components of a signal. Signal attenuation causes distortion of the waveform of a signal that is received by a receiver circuit. Distortion of the waveform of a signal is caused by not only the attenuation of high-frequency components in a transmission path but also reflection that occurs at a connecting portion between a package and a board, a connector, etc. The logical information (e.g., 0/1 binary values) of a transmission signal cannot be determined correctly from such a distorted signal. Therefore, this necessitates an amplifier circuit having an equalization function capable of amplifying a signal while eliminating distortion.

Distortion of a signal due to band restriction not only occurs in a transmission path and a package but also is caused by the high-frequency characteristics of a decision circuit (e.g., a receiver circuit that operates in synchronism with a clock) that determines the logical information (0/1) of a signal. This is because the bandwidth of the decision circuit is not limitlessly broad and hence signal values received by the decision circuit are those of a high-frequency-components-attenuated version of an input signal.

Another problem that is associated with the increase in transmission speeds relates to the accuracy of a clock that is used for signal reception. If fluctuations (jitter) exist in the timing of a clock, a signal cannot be received correctly even if a receiving signal has no distortion. The problems of the distortion of a transmission signal and the jitter of a clock become more serious as the transmission speed increases. Therefore, in designing an LSI or the like, conducting a circuit simulation by modeling these problems correctly is becoming indispensable for designing a circuit that operates reliably. In general, a circuit simulator such as Spice is used for designing a signal transmission circuit or verifying whether it operates in an expected manner. Capable of handling analog waveforms, Spice can correctly deal with waveform distortion etc. due to bandwidth restriction and can perform a correct simulation.

The following References 1 and 2 disclose simulation techniques using a behavior model for a clock and data recovery circuit using a binary decision circuit (logically, a flip-flop). In Reference 1, an output of a phase detector is determined as a nonlinear function of the difference between an input phase and a phase that is obtained by integrating the frequency of a VCO. A simulation is performed by dividing a continuous-time phenomenon into parts of short time steps.

Reference 1: Rick Walker, “Clock and Data Recovery for Serial Digital Communication Focusing on Bang-bang Loop CDR Design methodology,” ISSCC Short Course, February 2002.

Reference 2: Richard C. Walker, “Designing Bang-bang PLLs for Clock and Data Recovery in Serial Data Transmission Systems in Phase-Locking in High-performance System,” pp. 34-45, edited by Behzad. Razavi, IEEE Press/John Wiley & Sons, Inc., 2003.

### SUMMARY OF THE INVENTION

An object of the present invention is to provide a simulation method for accurately modeling an analog operation of a signal transmission circuit that receives and outputs a high-speed signal, and for accurate simulation by calculation in a short time.

According to one aspect of the invention, a step response or a pulse response (i.e., response function) including a bandwidth restriction effect of a transmission path is extracted from circuit data on a simulation subject in accordance with a sampling edge of a first clock in a clock synchronous circuit. The clock synchronous circuit is a circuit that receives or transmits a signal in synchronism with the first clock. A second discrete time model is generated by applying the response function to a first discrete time model generated according to the circuit data. Timing of the sampling edge of the first clock and an effective signal value of a signal that is input to and output from the clock synchronous circuit at this timing are calculated by using the second discrete time model. That is, the clock synchronous circuit is simulated by a computer.

For simulating a clock synchronous circuit with bandwidth restriction taken into consideration, it is necessary to accurately reproduce a circuit operation around a signal sampling edge of a first clock. On the other hand, the clock synchronous circuit can be regarded as not in operation at timings other than the timing of the sampling edge. According to the invention, extracting the clock synchronous circuit's step response or pulse response including the bandwidth restriction effect of a transmission path makes it possible to accurately simulate a circuit operation around a sampling edge of the first clock in an analog manner. The simulation is substantially unnecessary for timings other than the timing of the sampling edge. Therefore, it is able to accurately process as a discrete time model waveform distortion of a signal that is input to and output from a clock synchronous circuit operating at high speed, and to achieve accurate simulation in a short time through a minimum amount of calculation.

According to a preferable example in one aspect of the invention, response functions are extracted for storage for element circuits constituting the clock synchronous circuit. A synthesis response function for a state that the element circuits are connected to each other is calculated according to the stored response functions. The second discrete time model is generated by applying the synthesis response function to the first discrete time model. The response functions are extracted for storage for the respective element circuits so that even in the case where the characteristics of any of the element circuits are changed, the simulation can be executed by simply re-extracting a response function for the changed element circuit to re-calculate a synthesis response function. That is, a computer is prevented from making unnecessary calculation, which can shorten the simulation time. In addition, since the response functions are stored in correspondence with the element circuits, it is possible to enhance the maintainability of a simulation program to be executed by the computer.

According to another preferable example in one aspect of the invention, first, a first parameter indicating a relationship between noise and jitter of the first clock caused by the noise is extracted. Next, jitter is generated in the first clock according to the first parameter to give jitter to the second discrete time model. Timing of a sampling edge of the first clock having the jitter and an effective signal value of a signal that is input to and output from the clock synchronous circuit at this timing are calculated by using the second discrete time model. An accurate simulation can be performed with not only waveform distortion of a signal input to/output from the clock synchronous circuit but also jitter of the first clock taken into consideration, so that it is possible to execute simulation with even higher accuracy in a short time.

According to another preferable example in one aspect of the invention, the first parameter is extracted from a relationship between a difference in phase between periodic noise and activation timing of the first clock and jitter of the first clock caused by the periodic noise. The extracted first parameter is stored in a table. A simulation is feasible by simply storing the first parameters corresponding to noise in one cycle. Also, the simulation is feasible by just referring to the table or interpolating the first parameters stored in the table. This can further reduce the calculation for the simulation.

According to another preferable example in one aspect of the invention, first, a second parameter indicating a relationship between noise and jitter in a second clock caused by the noise is extracted. The second clock is a regeneration clock generated by a clock regeneration circuit that is included in a circuit as the simulation subject. Next, jitter is generated in the second clock according to the second parameter to give jitter to the second discrete time model. An effective signal value of the second clock having the jitter that is output from the clock regeneration circuit is calculated by using the second discrete time model. In general, since a first clock is supplied from outside the circuit as the simulation subject, only needed is calculation of how a sampling edge of the supplied first clock fluctuates. In contrast, in the clock regeneration circuit, jitter in the second clock gives influence on the timing of the next edge of the second clock. Separately calculating jitter of the first clock that is not fed back and jitter of the second clock (regeneration clock) that is fed back makes it possible to perform a simulation with high accuracy in each circuit.

According to still another preferable example in one aspect of the invention, a plurality of clock domains are provided in a circuit as a simulation subject, and circuits in the clock domains operate in synchronism with a plurality of first clocks. In this example, first, a relative relationship among sampling edges of the first clocks that are used in the respective clock domains is extracted. Second, a timing manager generates the first clocks in sequence according to the extracted relative relationship. Simulations of the clock domains are performed according to the first clocks generated in sequence. The use of the timing generator enables a high-accuracy simulation even in the case where a plurality of clock domains are present.

According to yet another preferable example in one aspect of the invention, the second discrete time model is generated automatically in response to a user's selection of at least one of a plurality of templates. Each template includes the first discrete time model generated in advance for each of element circuits constituting the clock synchronous circuit. Automatically generating a simulation model (i.e., second discrete time model) makes it possible to perform a simulation with a minimum load for a user.

According to a further preferable example in one aspect of the invention, timing information on signals that are transmitted to element circuits in the second discrete time model is converted into circuit diagram information representing logic of a circuit as the simulation subject. A circuit diagram is displayed on a display device on the basis of the circuit diagram information, using a graphical user interface. According to the invention, a simulation is performed by using, for example, a bit string of a transmission signal and a sequence of clock edge timings. Therefore, when the user executes the simulation, with mere display of such information on the display device, it is difficult for the user to understand the correspondence between the displayed circuit and his/her intended circuit for the simulation. According to the invention, the user can arrange element circuits and lay wirings among these circuits through manipulations similar to those to a general editor, without considering the second discrete time model. This makes it possible to construct and debug a circuit model easily.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing the basic principle of the present invention;

FIG. 2 is a block diagram showing a first embodiment of the invention;

FIG. 3 shows exemplary response functions that are extracted by a parameter extraction block shown in FIG. 2;

FIG. 4 is a waveform diagram of a step response of a transmission path that is extracted by one parameter extraction unit shown in FIG. 2;

FIG. 5 is a waveform diagram of an impulse response of a decision circuit that is extracted by the parameter extraction unit shown in FIG. 2;

FIG. 6 is a waveform diagram of an effective step response of the decision circuit including the transmission path that is extracted by a synthesis unit shown in FIG. 2;

FIG. 7 is a block diagram showing a second embodiment of the invention;

FIG. 8 is a block diagram showing a third embodiment of the invention;

FIG. 9 shows an exemplary noise/jitter transfer that is extracted by a parameter extraction block shown in FIG. 8;

FIG. 10 shows a waveform of an ISF of only a clock buffer;

FIG. 11 shows a waveform of a sampling clock that was used for obtaining the ISF of FIG. 10;

FIG. 12 shows a waveform of an ISF of the clock buffer plus a phase interpolator connected thereto;

FIG. 13 shows a waveform of a sampling clock that was used for obtaining the ISF of FIG. 12;

FIG. 14 is a block diagram showing a fourth embodiment of the invention;

FIG. 15 is a block diagram showing a fifth embodiment of the invention;

FIG. 16 is a block diagram showing a sixth embodiment of the invention; and

FIG. 17 is a block diagram showing a seventh embodiment of the invention.

### DESCRIPTION OF THE PREFERRED EMBODIMENTS

The present invention has been made to solve the following problems. In general, in discrete time models, the internal states of a circuit are calculated only every discrete time point rather than in continuous time. Therefore, the amount of calculation is small and a simulation can be performed at high speed. On the other hand, discrete time models cannot deal with waveform disorder due to an insufficient bandwidth in a circuit or a transmission path through which a wide-bandwidth signal is transmitted. This results in a problem that various problems due to increase in transmission speed, such as distortion and jitter, cannot be checked by a simulation.

To deal with an effect of waveform distortion and effect of jitter of a clock due to bandwidth restriction of a transmission path or a transmitter/receiver circuit, a simulator such as Spice capable of handling analog signals is necessary. However, simulators of this kind are slow in calculation speed and the number of transmission bits that can be processed per unit time of a simulation is as small as about 0.5 symbol/s. In general, to verify that a signal transmission circuit operates correctly, a simulation needs to be performed for about 10⁵ symbols. To check resistance to jitter having a certain frequency, calculations need to be performed at about 100 points for one jitter frequency. Evaluation at one point requires calculations of about 10⁵ symbols. This means that simulators such as Spice cannot perform sufficient verification (simulation) of a circuit operation in which distortion of a transmission signal and jitter of a clock are taken into consideration.

Embodiments of the present invention will be hereinafter described with reference to the drawings.

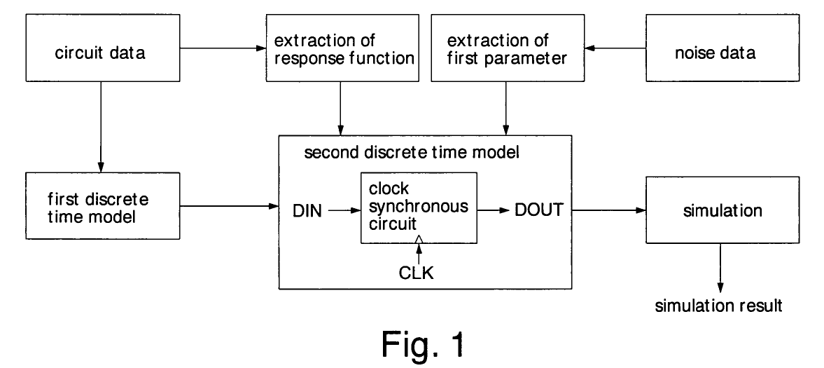

FIG. 1 shows the basic principle of the invention. In the invention, first, a response function is extracted from circuit data of a simulation subject. An example of the simulation subject is a clock synchronous circuit (a kind of decision circuit) that receives a signal DIN in synchronism with a first clock CLK and outputs a signal DOUT corresponding to the received signal DIN. The response function is a step response or a pulse response of the clock synchronous circuit including the bandwidth restriction effect of a transmission path. Further, a first parameter (jitter parameter) indicating a relationship between noise data (power supply noise or internal noise) and jitter of the first clock CLK caused by this noise is extracted. Then, a second discrete time model is generated by applying the response function and the first parameter to a first discrete time model that was generated in advance on the basis of the circuit data. Then, timing of a sampling edge of the first clock CLK and effective signal values of a signal that is input to and output from the clock synchronous circuit with this timing are calculated by using the second discrete time model. That is, a computer simulation of the clock synchronous circuit is performed and a simulation result is output.

To shorten the calculation time of a simulation, the invention employs the following principles:

(a) Employs the phase (clock edge timing) as a simulation variable.

(b) Performs a discrete time simulation.

(c) Reduces the amount of calculation by utilizing prescience of a signal (digital signal).

First, a discrete time simulation employing the phase as a simulation variable is performed in the following manner. A time tₙ₊₁ of an (n+1 )th-cycle clock edge is calculated according to Equation (1) by using a time tₙ of an nth-cycle clock edge and a nominal value fₙ₀ of an oscillation frequency of a clock generation circuit such as a VCO:
tₙ₊₁=tₙ+1/fₙ₀+δtₙ (1)
where δtₙ is the magnitude of a timing variation (i.e., jitter) occurring in the nth cycle. The parameter δtₙ is given as a function of a variation in this cycle of the oscillation frequency of the clock generation circuit and noise that depends on random noise and power supply noise that occur in this cycle, and is calculated cycle by cycle. Where a phase interpolator is driven by the clock of the clock generation circuit, a timing shift term that depends on a control code of the phase interpolator is added to Equation (1).

Since the above items (a) and (b) mean that a continuous time simulation is not performed, it is easily understood that the amount of calculation of a simulation can be reduced by the application of the invention. That is, the amount of calculation that is necessary for a simulation can be reduced by employing the phase as a simulation variable while not dealing with analog values of a clock waveform. Where the phase is calculated as a continuous time quantity, the amount of calculation increases because calculations need to be performed many times with very short time steps as described in the above-mentioned Reference 2. In contrast, the amount of calculation can be reduced by performing a discrete time simulation.

As for item (c), in general, clock waveforms are given “sufficiently large amplitudes.” That is, even in the case of what is called a small-amplitude clock, a circuit that is driven by the clock is usually designed so that the clock amplitude is sufficiently large for its operation. It can thus be said that the clock amplitude is “sufficiently large.” Therefore, in conventional simulations, even in the case where an actual clock waveform is an analog waveform, a simulation need not deal with an analog waveform and is required to take only a timing deviation into consideration.

In contrast, a signal that is received via a signal transmission path has waveform distortion due to intersymbol interference (ISI) because their high-frequency components have attenuated. Further, where decisions are made with timing of not only the center of a bit cell (one unit of transmission data) but also its boundaries, decisions are made on the signal at positions close to zero-cross points of the waveform of the transmission data. That is, a correct answer cannot be obtained unless a simulation is performed in such a manner as to take analog values of the signal amplitude into consideration. On the other hand, performing an analog simulation in continuous time requires a large amount of calculation and a long simulation time.

However, where a signal to be handled is not a general signal but a signal whose properties are known in advance and is subjected to decision by a clock synchronous circuit (decision circuit) that operates in an approximately constant clock cycle, the amount of calculation can be reduced to a large extent. More specifically, the amount of calculation can be reduced in the case where a transmitted signal that is a binary signal driven by a clock having an “approximately constant” cycle and is subjected to decision by a decision circuit driven by a clock having an “approximately constant” cycle (may be different from the former clock cycle).

In the following description, the time point of a clock edge when the decision circuit makes a decision on the current bit is made the origin of time (t=0) and all other time points are expressed as relative values with respect to the time point of this clock edge. In general, a transmitted signal reaches the input of the decision circuit via a transmitter and a transmission path. Since a signal before entering the transmitter is a digital signal, as far as this signal is concerned, the effect of an analog amplitude variation need not be taken into consideration, that is, only a timing variation needs to be taken into consideration. Therefore, a signal before entering the transmitter is given by an ideal binary signal X(t) of Equation (2):

$$X ( t ) = {\sum }_{n = - ∞}^{∞} {X}_{n} Π ( t , {τ}_{n} , {τ}_{n + 1} ) \qquad ( 2 )$$

where Xₙ is a signal value of an nth bit and takes a value −1 or +1 (−1 and +1 are used instead of 0 and 1 because differential transmission is assumed in this example) and Π(t, τ₁, τ₂) represents a pulse waveform (unit pulse waveform) that has a value “1” in an interval of t=τ₁ to τ₂ and has a value “0” in the other intervals. The value “0” means that the transmission line is not driven at all, that is, no signal exists. Symbol τₙ represents an edge time point of an nth binary signal on the transmitter side and is, as described above, a relative value with respect to the rise time of a clock edge in the decision circuit.

The effect that is produced by causing the binary signal of Equation (2) to pass through the transmitter, the transmission path, and the decision circuit is equivalent to the convolution integral of an effective impulse response h_{eq}(t) of these three elements combined and the waveform X(t). That is, an output waveform Y(t) of the decision circuit is given by Equation (3). Mark “\hat{x}” (mark “*” will be used instead in the text) in Equation (3) means a convolution integral.

$$Y ( t ) = ⌊ {\sum }_{n = 0}^{∞} {X}_{n} Π ( t , {τ}_{n} , {τ}_{n + 1} ) ⌋ ⊗ {h}_{eq} ( t ) \qquad ( 3 )$$

Where the convolution of Π(t, τₙ, τₙ₊₁) and h_{eq}(t) is calculated first, Equation (4) holds:

$$Y ( t ) = {\sum }_{n = 0}^{∞} {X}_{n} [ Π ( t , {τ}_{n} , {τ}_{n + 1} ) ⊗ {h}_{eq} ( t ) ] \qquad ( 4 )$$

That is, if a convolution waveform of the unit pulse waveform Π(t, τₙ, τₙ₊₁) and h_{eq}(t) is known, the magnitude of a signal that is output effectively from the decision circuit is obtained by calculating the sum of the products of convolutions and weights Xₙ. The amount of calculation of the weighted addition is small because it is a sum-of-products operation including a certain number of terms. The convolution integral in Equation (4) can be modified to Equation (6) by using the fact that Π(t, τₙ, τₙ₊₁) is given by Equation (5):
Π(t, τₙ, τₙ₊₁)=u(t−τₙ)−u(t−τₙ₊₁) (5)
Π(t, τₙ, τₙ₊₁)\textcircled{x}h_{eq}(t)=u(t−τₙ)\textcircled{x}h_{eq}(t)−u(t−τₙ₊₁)\textcircled{x}h_{eq}(t) (6)
where u(t) is a unit step function that rises at t=0. That is, if an effective response (response function) “u(t)*h_{eq}(t)” of the decision circuit for the unit step function u(t) is determined and stored prior to a simulation, an output of the decision circuit can be obtained by performing a sum-of-products operation including a certain number of terms in actual simulation.

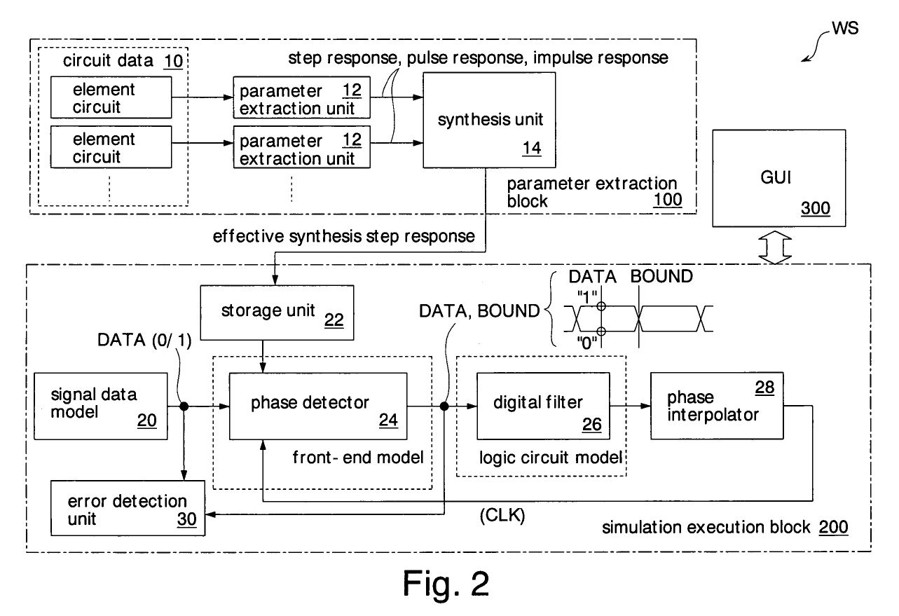

FIG. 2 shows a first embodiment of the invention. Each element in FIG. 2 is a program that is executed by a workstation WS (computer) or data (file) that is accessed by the workstation WS. Each item of data is used by the workstation WS for executing a program or generated by the workstation WS's executing a program. Those programs and those items of data are stored on a recording medium such as a magnetic tape, an optical disc (MO or CD-ROM), a magnetic disk (hard disk drive), or the like. In general, a program is transferred to the hard disk drive of the workstation from the magnetic tape, optical disc, or the like, and stored in a hard disk drive of the workstation WS so as to be executable by the workstation WS.

In the following description, each element will be described as a component of the workstation WS.

The workstation WS has a first parameter extraction block 100, a simulation execution block 200, and a graphical user interface (GUI) 300. The workstation WS also has, in addition to the components shown in FIG. 2, peripheral devices such as a keyboard, a mouse, a liquid crystal display device, and a printer. The workstation WS functions as a circuit analysis apparatus for analyzing an operation of a circuit that operates in synchronism with a clock.

The first parameter block 100 has circuit data 10, parameter extraction units 12 corresponding to respective circuit elements of the circuit data 10, and a synthesis circuit 14 that is common to the parameter extraction units 12. The circuit data 10 are data that are used by a circuit simulator such as Spice, and being written with the element circuit (e.g., a clock synchronous receiver circuit, a digital filter) of a simulation subject. Each parameter extraction unit 12 extracts a step response or a pulse response including a bandwidth restriction effect of a transmission path connected to the corresponding element circuit, and an impulse response to a signal supplied to the corresponding element circuit.

The synthesis unit 14 calculates the convolution of the step response and the impulse response or of the pulse response and the impulse response that have been extracted by each extraction unit 12. For example, the synthesis unit 14 calculates the convolution of a step response of a transmission path and an effective impulse response of a decision circuit. Then, the synthesis unit 14 determines a response of a front-end circuit including the bandwidth restriction effect of the transmission path as a response function that is an effective step response (or effective pulse response). For example, the front-end circuit is a clock synchronous circuit (decision circuit) that receives a signal that is synchronized with a clock.

As described above, the parameter extraction units 12 and the synthesis unit 14 function as an extraction unit for extracting an effective step response (or effective pulse response) of the clock synchronous circuit including the bandwidth restriction effect of the transmission path by using the circuit data 10 of the simulation subject. The effective step response (or effective pulse response) is a kind of what is called behavior parameter that represents features of an operation of each element circuit.

The simulation execution block 200 has a signal data model 20, a storage unit 22, a phase detector 24, a digital filter 26, a phase interpolator 28, and an error detection unit 30. The signal data model 20 functions as a transmitter that randomly generates logical values (0/1) of a transmission signal DATA that is input to the phase detector 24. The storage unit 22 stores, prior to a simulation, an effective synthesis step response that has been extracted by the parameter extraction block 100. Then, the simulation execution block 200 generates a second discrete time model (a front-end model and a logic circuit model) by applying the effective step response (response function) stored in the storage unit 22 to a first discrete time model (not shown) that was generated by a user (designer) or the like in advance. In this example, the front-end model is what has been modeled as the phase detector 24 representing an operation of a clock synchronous circuit (decision circuit) that receives a signal in synchronism with a clock CLK (first clock).

The logic circuit model is what has been modeled as the digital filter 26 that receives data DATA and BOUND that are output from the front-end model and outputs a filter response to the interpolator 28. As shown in FIG. 2, the data DATA and BOUND are values obtained by binary decision in regions where the logical value of the data is definite and values obtained by binary decision in transition regions of the data, respectively. That is, the data DATA and BOUND are definite data (having a logical value “0” or “1”) and boundary data (indefinite data) in transition regions of the data, respectively. The digital filter 26 detects a phase lead or delay of the clock CLK with respect to the data by detecting definite data and boundary data. The phase interpolator 28 adjusts the phase of the clock CLK on the basis of a detection result of the digital filter 26 and outputs as clock information to the phase detector 24.

The simulation execution block 200 calculates effective input values on the basis of the effective step response stored in the storage unit 22 and a bit string DATA (0/1) that is sent to the transmission path. That is, a simulation is performed by using the discrete time model. The error detection unit 30 determines a simulation result by comparing input data and output data of the phase detector 24. The simulation result is displayed on the display device such as a CRT via the graphical user interface (GUI) 300.

The graphical user interface (GUI) 300 converts timing information of signals that are exchanged by element circuits of the second discrete time model to circuit diagram information representing the logic of the simulation subject circuit and displays a circuit diagram on the display device on the basis of the circuit diagram information thus obtained. In the invention, for example, a simulation is performed by using a bit string of a transmission signal and a sequence of clock edge timing. Therefore, when such information is merely displayed on the display device, it is difficult for the user who performs a simulation to understand the correspondence between the displayed circuit and the actual circuit as the simulation subject. According to the invention, the user can arrange element circuits and wire those circuits through manipulations similar to manipulations that are performed in using a general editor, without being aware of the second discrete time model.

The invention employs a characteristics calculation method according to a behavior model (a front-end model and a logic circuit model) obtained by paying attention to operation characteristics (behavior) of a circuit. In general, a transmission circuit that deals with a high-speed signal is formed as a combination of a decision circuit (clock synchronous circuit) that generates or detects a signal in synchronism with a clock and a continuous time circuit (e.g., amplifier circuit) that processes an input signal without receiving a clock. Various problems that are associated with high-speed signal transmission are caused by the fact that a signal that has been bandwidth-restricted by the continuous time circuit including a transmission path is received by the clock synchronous circuit in which bandwidth restriction is also caused or the clock has jitter. In general, the clock synchronous circuit samples an input with such timing that the clock turns active and sends an output corresponding to the input to the next-stage circuit. The effective value of an input that is sampled by the clock synchronous circuit can be determined by taking the input-side bandwidth restriction and the bandwidth restriction of the clock synchronous circuit itself into consideration. A signal that has been sampled once by the clock synchronous circuit can be handled by a discrete time simulation because it is sufficient to process only values of discrete timing with which the clock turns active. The amount of calculation of a discrete time simulation is much smaller than that of a continuous time simulation because it is sufficient to evaluate only signal values of discrete timing. That is, where a waveform that has been bandwidth-restricted by a transmission line or an amplifier circuit is sampled by a clock synchronous circuit such as a front-end circuit (decision circuit) or a clocked comparator, the application of the invention shortens the calculation time of effective values of a signal.

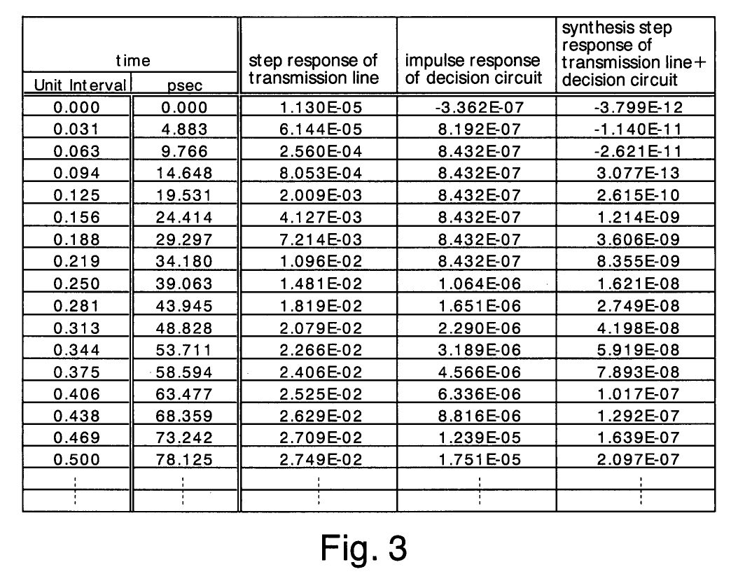

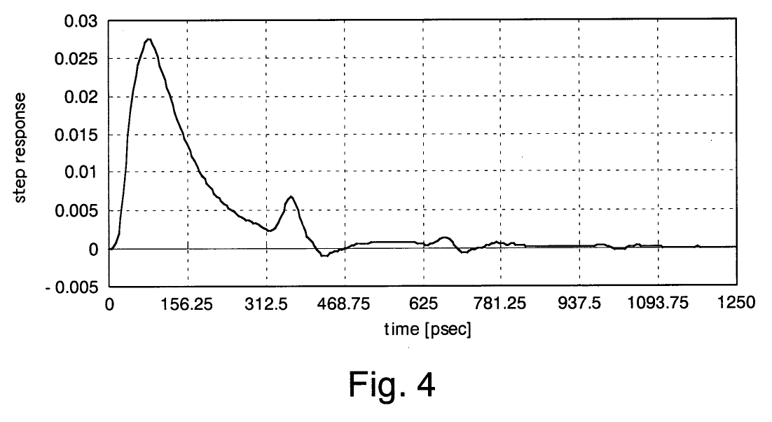

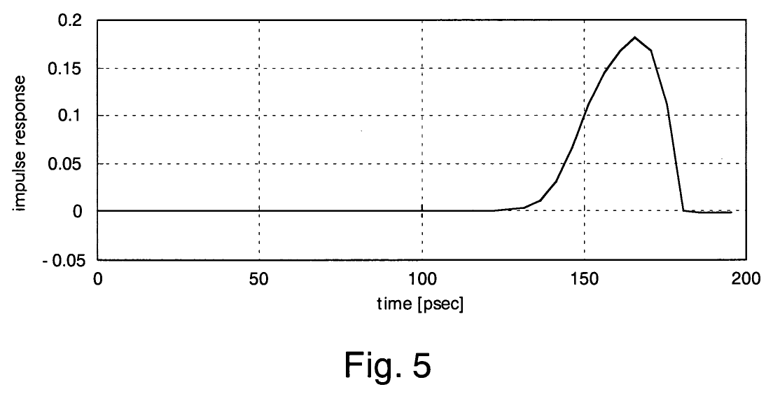

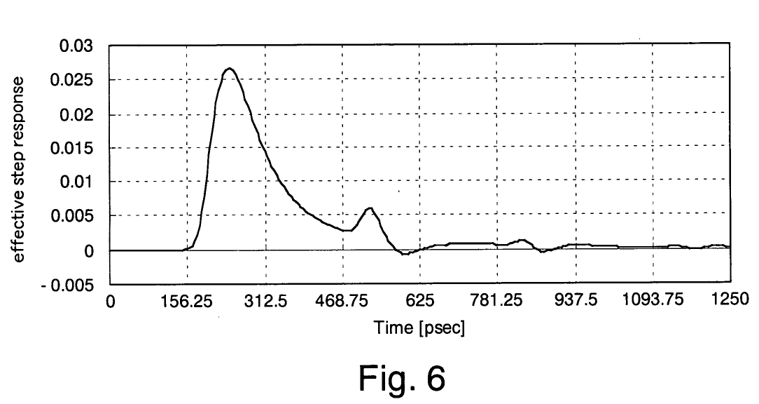

FIG. 3 shows exemplary response functions that are extracted by the parameter extraction block 100 shown in FIG. 2. In this example, first, each of the parameter extraction units 12 extracts a step response of a transmission path and an impulse response of a decision circuit. Then, the synthesis unit 14 extracts an effective synthesis step response of the decision circuit including the transmission path by calculating the convolution of the extracted response functions. FIGS. 4-6 shows waveforms of the response functions shown in FIG. 3.

As described above, according to this embodiment, a circuit operation around a sampling edge of a first clock can be simulated correctly in an analog manner by extracting a step response or a pulse response of a clock synchronous circuit including the bandwidth restriction effect of a transmission path. It is substantially unnecessary to perform a simulation with timing excluding sampling edges. This makes it possible to correctly deal with, as a discrete time model, waveform distortion of a signal that is input to and output from a clock synchronous circuit that operates at high speed and to perform a high-accuracy simulation in a short time by minimizing the amount of calculation.

A user can arrange element circuits and wire those circuits through manipulations similar to manipulations that are performed in using a general editor, without being aware of a second discrete time model. As a result, the user can construct and debug a circuit model easily.

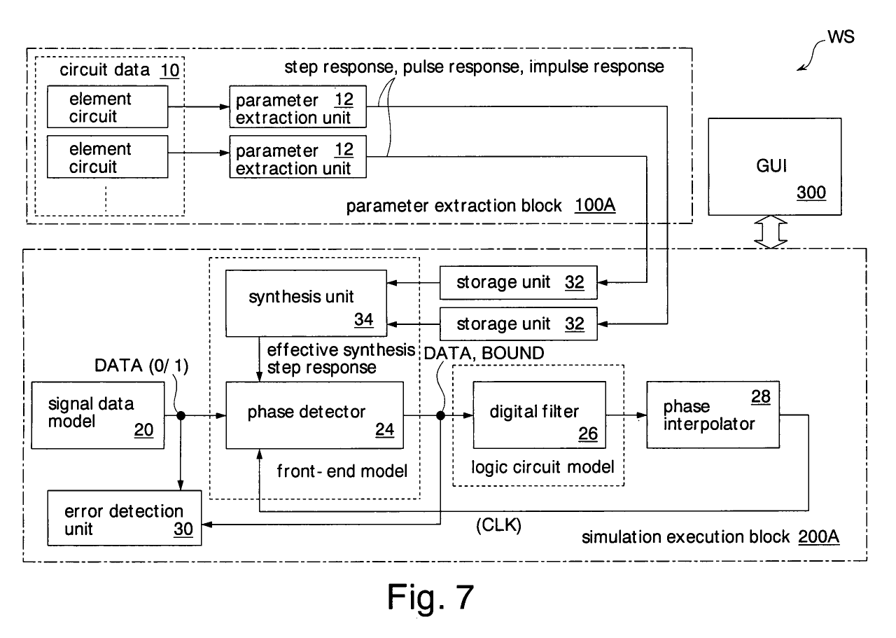

FIG. 7 shows a second embodiment of the invention. Elements in the second embodiment having the same elements in the first embodiment are given the same reference symbols as the latter and will not be described in detail. As in the first embodiment, each element in FIG. 7 is a program that is executed by a workstation WS (computer) or data (file) that is accessed by the workstation WS. The system configuration of the workstation WS is the same as in the first embodiment. In the following description, each element will be described as a component of the workstation WS.

In this embodiment, a simulation execution block 200A is provided with storage units 32 and a synthesis unit 34. The storage units 32 are provided for the respective parameter units 12 and store response functions that are extracted by the respective parameter units 12. The synthesis unit 34 calculates an effective synthesis response by using the responses stored in the storage unit 32. The synthesis unit 34 is included in a front-end model. A first parameter extraction block 100A does not include the synthesis unit 14 of the first embodiment. The other part of the configuration is the same as in the first embodiment.

In this embodiment, response functions are extracted for the respective element circuits constituting a clock synchronous circuit and are stored in the respective storage units 32. The synthesis unit 34 calculates a synthesis response function for a state that the elements circuits are connected to each other on the basis of the stored response functions. A second discrete time model is generated by applying the synthesis response function to a first discrete time model that was generated in advance. For example, extracting and storing response functions for the respective element circuits makes it possible to perform a simulation while changing the characteristics of part of the element circuits merely by extracting response functions of those element circuits again and calculating a synthesis response function again. Further, since the response functions correspond to the respective element circuits, the maintainability of a simulation program to be executed by the workstation WS can be increased.

As described above, the second embodiment provides the same advantages as the first embodiment does. Further, the workstation WS is prevented from performing useless calculations when the characteristics of part of the element circuits are changed, whereby the simulation time can be shortened.

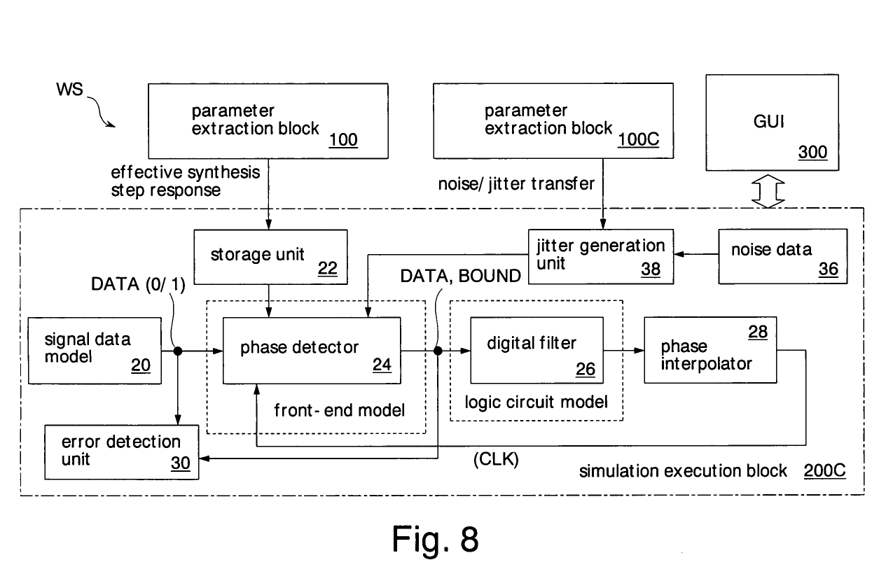

FIG. 8 shows a third embodiment of the invention. Elements in the third embodiment having the same elements in the first embodiment are given the same reference symbols as the latter and will not be described in detail. As in the first embodiment, each element in FIG. 8 is a program that is executed by a workstation WS (computer) or data (file) that is accessed by the workstation WS. The system configuration of the workstation WS is the same as in the first embodiment. In the following description, each element will be described as a component of the workstation WS.

In addition to the functions of the first embodiment, this embodiment has a function for performing a simulation taking jitter of a clock into consideration. To this end, the work station WS has a second parameter extraction block 100C in addition to the first parameter extraction block 100. A simulation execution block 200C has noise data 36 and a first jitter generation unit 38 in addition to the units of the simulation execution block 200 of the first embodiment.

Prior to a simulation, the second parameter extraction block 100C extracts, from the circuit data, jitter (noise/jitter transfer: behavior parameter (first parameter)) of a clock buffer that is caused by external noise such as power supply noise. For example, the clock buffer is formed in an LSI to receive an external clock (first clock CLK) and to output the received clock to internal circuits. The extracted transfer is stored in a storage unit (not shown) of the parameter extraction block 100C.

The noise data 36 of the simulation execution block 200C is calculated by Spice or the like prior to a simulation. In the case of a clock for driving a circuit, a fluctuation of timing with which the clock turns active (i.e., jitter) in each cycle is used. Being a variable that is defined only at rises of the clock, the jitter can be dealt with by a discrete time model. Therefore, the first jitter generation unit 38 is formed as a discrete time model (FIR filter or IIR filter).

The first jitter generation unit 38 receives power supply noise data (noise information) from the noise data 36 and calculates, by using the noise/jitter transfer, jitter that is caused by the noise data. That is, the first jitter generation unit 38 generates jitter on the basis of the noise data using the behavior parameter relating to the generation of jitter and supplies the generated jitter to a second discrete time model. Timing of a sampling edge of the first clock having jitter and an effective signal value of this timing of a signal that is input to and output from a clock synchronous circuit (front-end model) are calculated by using the second discrete time model. More specifically, a clock edge having jitter is determined by adding, in the front end, the jitter supplied from the jitter generation unit 38 to a clock phase that is supplied from a phase interpolator 28. Therefore, the simulation execution block 200C performs a simulation taking into consideration the jitter as well as signal waveform distortion due to the bandwidth restriction of the transmission line and the decision circuit. Where the phase interpolator 28 generates jitter, the jitter from the jitter generation unit 38 may be supplied to the phase interpolator 28.

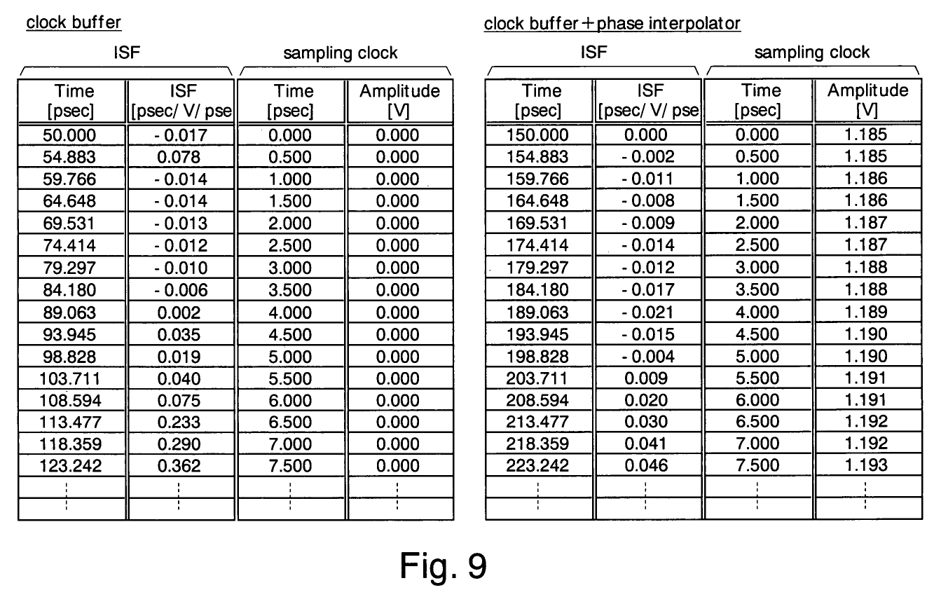

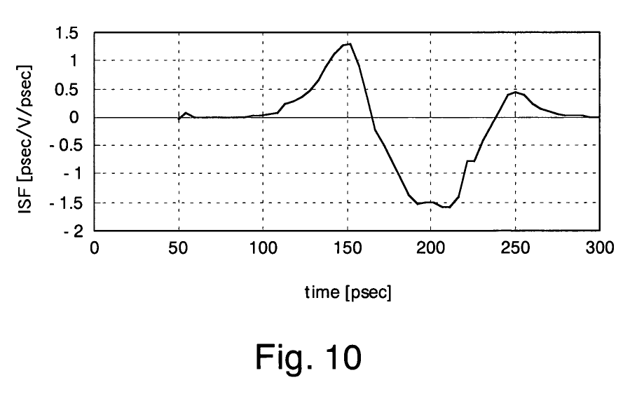

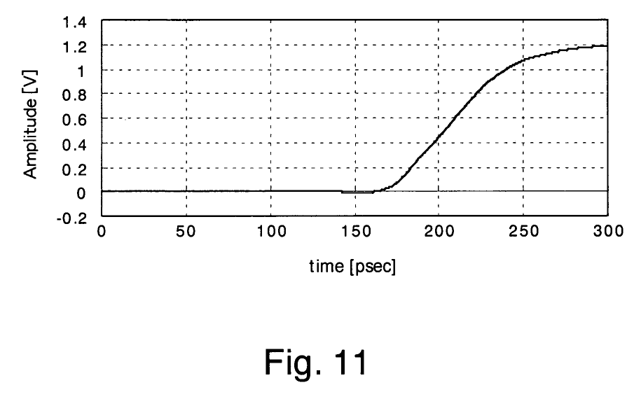

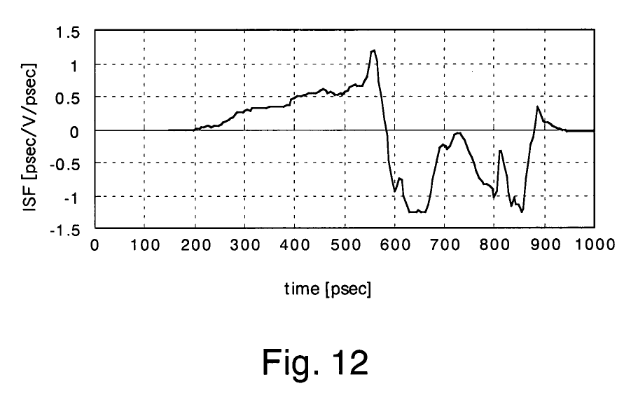

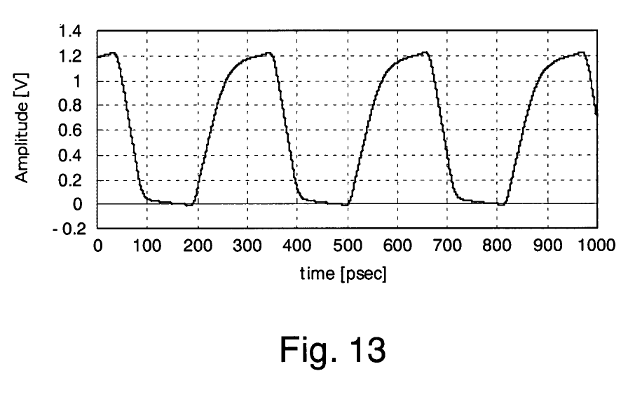

FIG. 9 shows an exemplary noise/jitter transfer that is extracted by the parameter extraction block 100C shown in FIG. 8. The noise/jitter transfer is shows as an ISF (impulse sensitivity function). FIG. 9 shows an ISF of only a clock buffer, an ISF of the clock buffer plus a phase interpolator connected thereto, and sampling clocks that were supplied to a decision circuit to obtain the ISF. FIG. 10 shows a waveform of the ISF of only the clock buffer. FIG. 11 shows a waveform of the sampling clock that was used for obtaining the ISF of FIG. 10. FIG. 12 shows a waveform of the ISF of the clock buffer plus the phase interpolator connected thereto. FIG. 13 shows a waveform of the sampling clock that was used for obtaining the ISF of FIG. 12.

As described above, the third embodiment provides the same advantages as the first embodiment does. Further, in the third embodiment, a correct simulation can be performed by taking into consideration not only waveform distortion of a signal that is input to and output from a clock synchronous circuit but also jitter of a first clock. This makes it possible to perform a simulation of even higher accuracy in a short time.

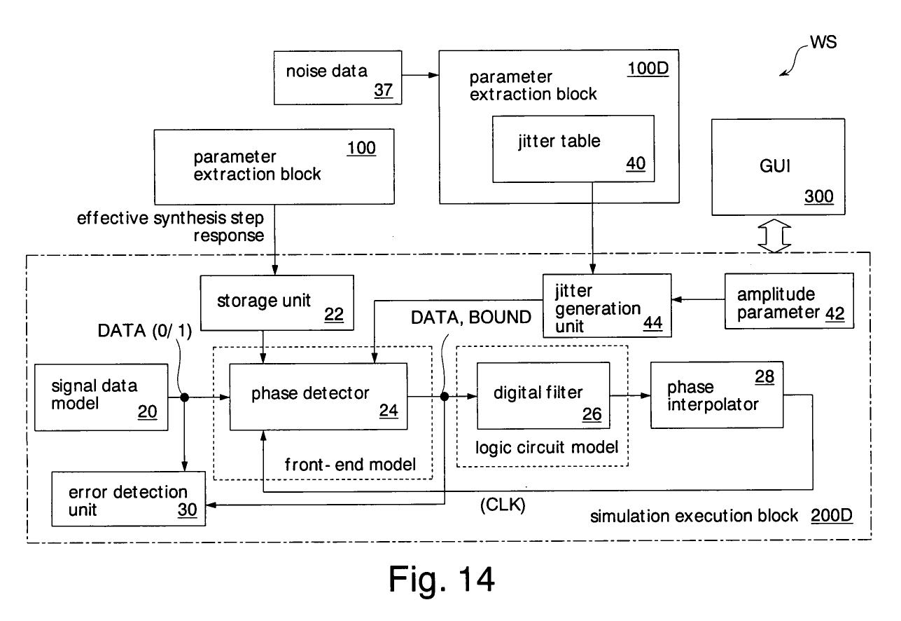

FIG. 14 shows a fourth embodiment of the invention. Elements in the fourth embodiment having the same elements in the first or third embodiment are given the same reference symbols as the latter and will not be described in detail. As in the first embodiment, each element in FIG. 14 is a program that is executed by a workstation WS (computer) or data (file) that is accessed by the workstation WS. The system configuration of the workstation WS is the same as in the first embodiment. In the following description, each element will be described as a component of the workstation WS.

In general, in most LSIs, the internal circuits operate cyclically and power supply noise occurs periodically. Jitter that is caused by the power supply noise also tends to occur periodically. In view of this, this embodiment has, in addition to the functions of the first embodiment, a function for performing a simulation taking into consideration jitter that occurs periodically. The workstation WS has a third parameter extraction block 100D in place of the second parameter extraction block 100C of the third embodiment. For example, noise data 37 are data that are obtained by modifying the noise data 36 of the third embodiment so that they will have periodicity. The third parameter extraction block 100D extracts, from the noise data 37, a relationship (first parameter) between clock edge phases with respect to a noise waveform and resulting jitter and stores it in a jitter table 40. A simulation can be performed once first parameter values corresponding to noise of one cycle have been stored in the jitter table 40.

In the case of periodic noise, the magnitude of jitter that is caused by the noise can be obtained merely by knowing a relative position of a clock edge concerned with respect to a periodic waveform of the noise. Therefore, jitter can be calculated by searching (looking up) the jitter table 40. Where the number of first parameter values stored in the jitter table 40 is small, jitter can be calculated by such processing as interpolation.

The search of the jitter table 40 and the interpolation are performed by a jitter generation unit 44. Further, the jitter generation unit 44 can change the amplitude of a clock (first clock) CLK by using an amplitude parameter 42. A simulation can be performed by the jitter generation unit 44's referring to the jitter table 40. The amount of calculation of a simulation can thus be reduced further.

As described above, the fourth embodiment provides the same advantages as the first and third embodiments do. Further, the amount of calculation of a simulation can be reduced further by storing a relationship between clock edge phases with respect to a noise waveform and resulting jitter in the jitter table 40 in advance.

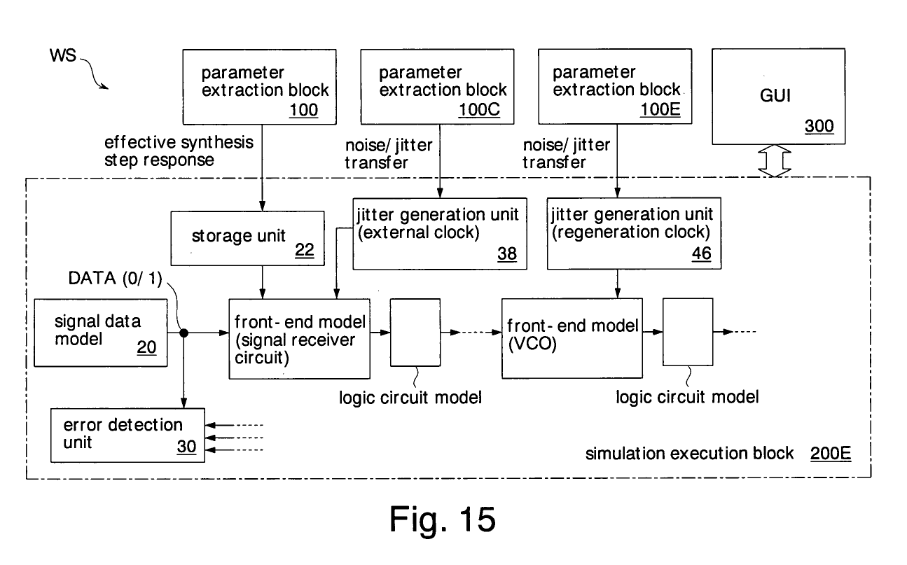

FIG. 15 shows a fifth embodiment of the invention. Elements in the fifth embodiment having the same elements in the first or third embodiment are given the same reference symbols as the latter and will not be described in detail. As in the first embodiment, each element in FIG. 14 is a program that is executed by a workstation WS (computer) or data (file) that is accessed by the workstation WS. The system configuration of the workstation WS is the same as in the first embodiment. In the following description, each element will be described as a component of the workstation WS.

In addition to the functions of the third embodiment, this embodiment has a function for performing a simulation taking into consideration jitter (jitter of a regeneration clock) occurring in a clock regeneration circuit such as a VCO that generates a clock (second clock) regeneratively using a feedback loop.

Where a circuit block as a simulation subject has a clock synchronous circuit that receives a signal in synchronism with a clock (or a clock driving circuit such as a clock buffer that operates receiving a clock) and a clock regeneration circuit, jitter occurring in each of these circuits needs to be calculated separately. This is because the clock is supplied externally to the clock synchronous circuit (or clock driving circuit) and it is sufficient to calculate how edges of the supplied clock fluctuate, whereas in the clock regeneration circuit jitter occurring at a certain clock edge influences the position of the next clock edge. Therefore, whereas for the clock synchronous circuit (or clock driving circuit) how much a clock edge deviates from its original position is calculated, for the clock regeneration circuit the position of a clock edge is calculated by adding a deviation caused by noise in the one cycle to the position of the clock edge one cycle before. To realize these functions, the workstation WS has a fourth parameter extraction block 100E for jitter of a regeneration clock in addition to the first and second parameter extraction blocks 100 and 100C of the third embodiment.

Like the second parameter extraction block 100C, the fourth parameter extraction block 100E extracts, from the circuit data, prior to a simulation, jitter (noise/jitter transfer: behavior parameter (second parameter)) of the clock regeneration circuit that is caused by external noise such as power supply noise. The extracted transfer is stored in a storage unit (not shown) of the fourth parameter extraction block 100E.

Like the first jitter generation unit 38, a second jitter generation unit 46 is formed as a discrete time model (FIR filter or IIR filter). Like the first jitter generation unit 38, the second jitter generation unit 46 receives power supply noise data (noise information) from noise data (not shown) and calculates, by using the noise/jitter transfer supplied from the fourth parameter extraction block 100E, jitter that is caused by the noise data. Timing of a sampling edge of a regeneration clock (second clock) having jitter and an effective signal value of this timing of a signal that is input to and output from the clock regeneration circuit (front-end model) are calculated by using a second discrete time model. Therefore, the simulation execution block 200E performs a simulation taking into consideration not only signal waveform distortion due to the bandwidth restriction of the transmission line and the decision circuit and jitter of the external clock but also the regeneration clock generated by the clock regeneration circuit.

As described above, the fifth embodiment provides the same advantages as the first and third embodiments do. Further, a correct simulation can be performed for a circuit block including a clock regeneration circuit such as a VCO with jitter of a regeneration clock taken into consideration. Further, where a plurality of VCOs are formed on a chip, this embodiment makes it possible to easily deal with interactions between those VCOs, oscillation frequency pulling effects of the VCOs, and other phenomena.

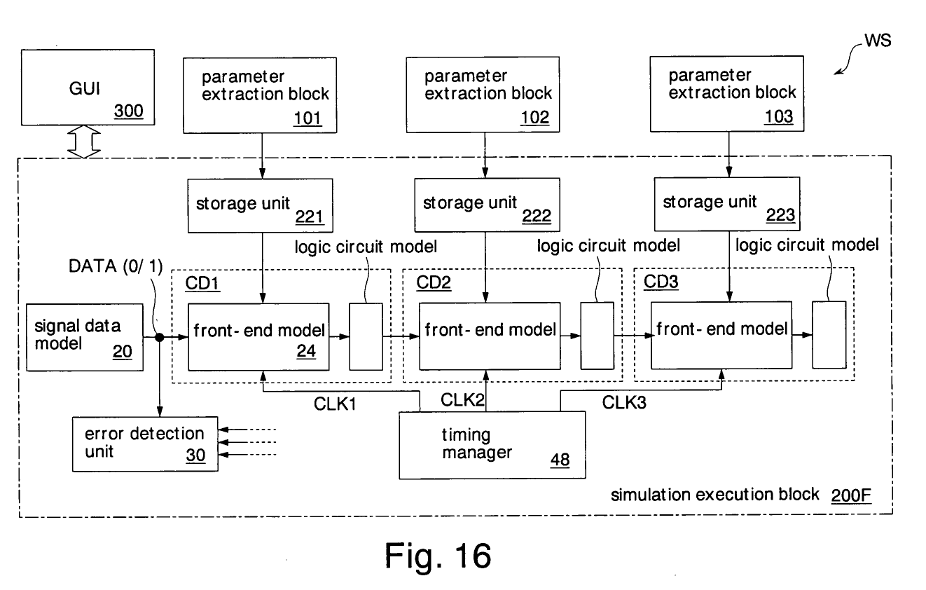

FIG. 16 shows a sixth embodiment of the invention. Elements in the sixth embodiment having the same elements in the first embodiment are given the same reference symbols as the latter and will not be described in detail. As in the first embodiment, each element in FIG. 16 is a program that is executed by a workstation WS (computer) or data (file) that is accessed by the workstation WS. The system configuration of the workstation WS is the same as in the first embodiment. In the following description, each element will be described as a component of the workstation WS.

In this embodiment, to perform a simulation of a circuit that consists of a plurality of clock domains CD1 to CD3, a simulation execution block 200F has a timing manager 48 that generates clocks in correct order. The clock domains CD1 to CD3 each correspond to the front-end model and the logic circuit model of the first embodiment, and operate in synchronism with different kinds of clocks (first clocks) CLK1 to CLK3, respectively. The periods of the clocks CLK1 to CLK3 may be either the same or different from each other. Parameter extraction blocks 101-103 and storage units 221-223 are provided so as to correspond to the respective front-end models. The parameter extraction blocks 101-103 and the storage units 221-223 correspond to the parameter extraction block 100 and the storage unit 22 of the first embodiment, respectively.

Where a plurality of clock domains CD1 to CD3 exist in a system, usually, the rising edges of clocks CLK1 to CLK3 belonging to the respective clock domains CD1 to CD3 vary independently of each other. A system having only a single clock domain can also be regarded as having many independent clock edges if jitter is taken into consideration. In an ordinary logic circuit, the circuit can capture data without depending on jitter as long as the jitter is too high. On the other hand, in a signal transmission circuit, the output of a decision circuit included therein may vary to a large extent depending on the positional relationship between clock edges. For example, such a phenomenon may occur when a decision circuit reads data with timing of a bit cell boundary.

In the example being considered, first, sampling edge timing relationships between first clocks CLK1 to CLK3 to be used in the respective clock domains CD1 to CD3 are extracted. Then, the timing manager 48 generates first clocks CLK1 to CLK3 in order according to the extracted relationships. Simulations for the clocked domains are performed by using the first clocks CLK1 to CLK3 that have been generated in order.

In this case, the timing relationships between clock edges greatly influence the circuit operation. Therefore, the positions of all clock edges that will influence the circuit operation are calculated and the element blocks of simulation models are made active in order in accordance with the order of the clock edges. That is, sampling edge timing relationships between clocks CLK1 to CLK3 to be used in the respective clock domains CD1 to CD3 are extracted and clocks CLK1 to CLK3 are generated in order according to the extracted relationships. More specifically, every time the front-end model of each of the clock domains CD1 to CD3 receives a clock pulse, it calculates the timing of the next clock edge on the basis of the timing of the current clock edge and returns information indicating the calculated timing to the timing manager 48 (extraction of a clock timing relationship). The timing manager 48 stores clock edge timing values that have been received from the front end models, and make active the clock of a front-end model corresponding to the smallest timing value among the stored timing values. The use of the timing manager 48 makes it possible to correctly deal with the order of clock edges even in the case where a plurality of clock domains exist or a transmission side and a reception side have different clock frequencies (e.g., a state that a clock recovery circuit is not locked at the time of a startup of an LSI).

As described above, the sixth embodiment provides the same advantages as the first and third embodiments do. Further, the use of the timing manager 48 makes it possible to perform high-accuracy simulation even in the case where a circuit block as a simulation subject consists of a plurality of clock domains.

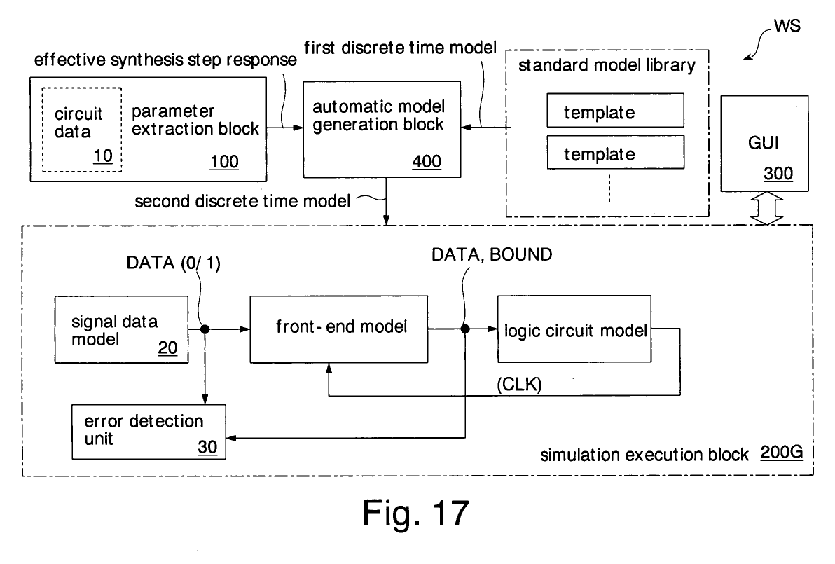

FIG. 17 shows a seventh embodiment of the invention. Elements in the seventh embodiment having the same elements in the first embodiment are given the same reference symbols as the latter and will not be described in detail. As in the first embodiment, each element in FIG. 17 is a program that is executed by a workstation WS (computer) or data (file) that is accessed by the workstation WS. The system configuration of the workstation WS is the same as in the first embodiment. In the following description, each element will be described as a component of the workstation WS.

This embodiment has a function of generating a simulation execution model (second discrete time model) automatically by selecting, from templates generated in advance, the template of a circuit block for which analog effects due to bandwidth restriction etc. should be taken into consideration among the circuit blocks of a circuit as a simulation subject. To realize this function, templates of circuit blocks for which analog effects should be taken into consideration (i.e., typical templates of high-speed signal transmission circuits) are generated in advance and registered as a standard model library. Exemplary circuit blocks whose templates are generated are a transmitter consisting of a multiplexer and a transmitter front end and a receiver consisting of a decision circuit, a demultiplexer, and a clock recovery circuit.

Then, the user inputs, through the graphical user interface (GUI) 300, information indicating correspondence between the template and a transmission circuit in the circuit block as the simulation subject. As in the first embodiment, the parameter extraction block 100 extracts an effective synthesis step response. An automatic model generation block 400 automatically generates a second discrete time model (front-end model and a logic circuit model) by applying the effective step response (response function) extracted by the parameter extraction block 100 to a first discrete model included in the designated template. By using the generated second discrete time model (front-end model and a logic circuit model), a simulation execution block 200G calculates effective input values on the basis of a bit string DATA (0/1) that is sent to the transmission path. That is, a simulation is performed by using the discrete time model.

As described above, the seventh embodiment provides the same advantages as the first embodiment does. Further, since a simulation execution model (second discrete time model) can be generated automatically, a simulation can be performed while the load of a user is minimized.

In the above embodiments, the invention is applied to the receiver circuit that receives a signal in synchronism with a clock. However, the invention is not limited to those embodiments. For example, the invention may be applied to a transmission circuit.

The features of the invention described in each of the third to seventh embodiments may be added to the second embodiment.

In the third embodiment, a simulation is performed by extracting a behavior model relating to jitter of a clock caused by power supply noise. However, the invention is not limited to this embodiment. For example, a simulation may be performed by extracting a behavior parameter relating to jitter of a clock caused by internal noise that is generated by such elements as transistors and resistors in an LSI.

The invention is not limited to the above embodiments and various modifications may be made without departing from the spirit and scope of the invention. Any improvement may be made in part or all of the components.

What is claimed is:

1. A method for analyzing, by a computer, a circuit that operates in synchronism with a clock, comprising the steps of:
extracting a response function from circuit data on a simulation subject in accordance with a sampling edge of a first clock in a clock synchronous circuit that receives or transmits a signal in synchronism with the first clock, the response function being one of a step response and a pulse response including a bandwidth restriction effect of a transmission path;
generating a second discrete time model by applying the response function to a first discrete time model that is generated from the circuit data; and
to perform a simulation, calculating, using the second discrete time model, a timing of the sampling edge and an effective signal value of a signal that is input to and output from said clock synchronous circuit at the timing of the sampling edge.

2. The method according to claim 1, further comprising the steps of:
extracting response functions for element circuits constituting said clock synchronous circuit;
storing the extracted response functions; and
calculating a synthesis response function for a state that the element circuits are connected to each other, according to the stored response functions, wherein
the second discrete time model is generated by applying the synthesis response function to the first discrete time model.

3. The method according to claim 1, further comprising the steps of:
extracting a first parameter indicating a relationship between noise and jitter of the first clock caused by the noise;
generating jitter in the first clock according to the first parameter to give jitter to the second discrete time model; and
to perform a simulation, calculating, using the second discrete time model, a timing of a sampling edge of the first clock having the jitter and an effective signal value of a signal that is input to and output from said clock synchronous circuit at the timing of the sampling edge.

4. The method according to claim 3, further comprising the steps of:
extracting the first parameter from a relationship between a difference in phase between periodic noise and the timing of the sampling edge of the first clock and jitter of the first clock caused by the periodic noise; and
storing the extracted first parameter in a table.

5. The method according to claim 3, further comprising the steps of:
extracting a second parameter indicating a relationship between noise and jitter in a second clock caused by the noise, the second clock being a regeneration clock generated by a clock regeneration circuit that is included in a circuit as a simulation subject;
generating jitter in the second clock according to the second parameter to give jitter to the second discrete time model; and
calculating, using the second discrete time model, an effective signal value of the second clock having the jitter.

6. The method according to claim 1, further comprising the steps of:
extracting a relative relationship among sampling edge timings of first clocks that are used in a plurality of clock domains, respectively, the clock domains being provided in a circuit as a simulation subject;
sequentially generating the first clocks by a timing generator according to the extracted relative relationship; and
performing simulations of the clock domains according to the first clocks generated in sequence.

7. The method according to claim 1, further comprising the step of generating the second discrete time model automatically in response to a user's selection of at least one of a plurality of templates that include a first discrete time model generated in advance for each of element circuits constituting said clock synchronous circuit.

8. The method according to claim 1, further comprising the steps of:
converting timing information on a signal in the second discrete time model into circuit diagram information representing logic of a circuit as a simulation subject, the signal being transmitted to each element circuit; and
displaying a circuit diagram on a display device on the basis of the circuit diagram information, using a graphical user interface.

9. An apparatus for analyzing operation of a circuit that operates in synchronism with a clock, comprising:
a first parameter extraction block extracting a response function from circuit data on a simulation subject in accordance with a sampling edge of a first clock in a clock synchronous circuit that receives or transmits a signal in synchronism with the first clock, the response function being one of a step response and a pulse response including a bandwidth restriction effect of a transmission path;
a model generation block generating a second discrete time model by applying the response function to a first discrete time model that is generated from the circuit data; and
a simulation execution block performing a simulation by calculating, using the second discrete time model, a timing of the sampling edge and an effective signal value of a signal that is input to and output from said clock synchronous circuit at the timing of the sampling edge.

10. The apparatus according to claim 9, further comprising:
a plurality of parameter extraction units provided in said first parameter extraction block, for extracting response functions for element circuits constituting said clock synchronous circuit;
a plurality of storage units storing the extracted response functions, respectively; and
a synthesis unit calculating a synthesis response function for a state that said element circuits are connected to each other, according to the stored response functions, wherein
said model generation block generates the second discrete time model by applying the synthesis response function to the first discrete time model.

11. The apparatus according to claim 9, further comprising:
a second parameter extraction block extracting a first parameter indicating a relationship between noise and jitter of the first clock caused by the noise; and
a first jitter generation unit generating jitter in the first clock according to the first parameter to give jitter to the second discrete time model, wherein
said simulation execution block performs a simulation by calculating, using the second discrete time model, a timing of a sampling edge of the first clock having the jitter and an effective signal value of a signal that is input to and output from said clock synchronous circuit at the timing of the sampling edge.

12. The apparatus according to claim 11, further comprising:
a third parameter extraction block extracting the first parameter from a relationship between a difference in phase between periodic noise and the timing of the sampling edge of the first clock and jitter of the first clock caused by the periodic noise; and
a jitter table storing the extracted first parameter.

13. The apparatus according to claim 11, further comprising:
a fourth parameter extraction block extracting a second parameter indicating a relationship between noise and jitter in a second clock caused by the noise, the second clock being a regeneration clock generated by a clock regeneration circuit that is included in a circuit as a simulation subject; and
a second jitter generation unit generating jitter in the second clock according to the second parameter to give jitter to the second discrete time model, wherein
said simulation execution block performs a simulation by calculating, using the second discrete time model, an effective signal value of the second clock having the jitter.

14. The apparatus according to claim 9, further comprising:
a timing manager extracting a relative relationship among sampling edge timings of first clocks that are used in a plurality of clock domains, respectively, and generating the first clocks in sequence according to the extracted relative relationship, the clock domains provided in a circuit as a simulation subject, wherein
said simulation execution block performs simulations of the clock domains according to the first clocks generated in sequence.

15. The apparatus according to claim 9, further comprising
an automatic model generation block generating the second discrete time model automatically in response to a user's selection of at least one of a plurality of templates that each include a first discrete time model generated in advance for each of element circuits constituting said clock synchronous circuit.

16. The apparatus according to claim 9, further comprising a graphical user interface converting timing information on a signal in the second discrete time model into circuit diagram information representing logic of a circuit as a simulation subject, and displaying a circuit diagram on a display device on the basis of the circuit diagram information, the signal being transmitted to each element circuit.
